(19) United States
(12) Patent Application Publication
(10) Pub. No.: US 2010/0075288 A1
(43) Pub. Date: Mar. 25, 2010

(54) EDUCATIONAL CONTENT CONFIGURATION USING MODULAR MULTIMEDIA OBJECTS

(75) Inventor: Seshukumar Sareday, San Jose, CA (US)

Correspondence Address: Raj Abhyanker LLP, 1580 West, El Camino Real, Suite 8, Mountain View, CA, 94040, US

(73) Assignee: EMANTRAS, INC, Fremont, CA (US)

(21) Appl. No.: 12/625,575

(22) Filed: Nov. 25, 2009

Related U.S. Application Data
(63) Continuation-in-part of application No. 11/545,969, filed on Oct. 10, 2006, now Pat. No. 7,647,352.
Application No. 11/545,969 is a continuation-in-part of application No. 11/702,710, filed on Feb. 5, 2007.
Application No. 11/702,710 is a continuation-in-part of application No. 11/702,836, filed on Feb. 5, 2007.

(51) Int. Cl. G09B 7/00; G06F 17/30

(52) U.S. Cl. 434/322; 707/769; 707/E17.014

(57) ABSTRACT

Several methods and a system for educational content configuration using modular multimedia objects are disclosed. In one embodiment a system includes an authoring module of a content module to create a first meta-data associated with each of a learning object with the first meta-data describing a context of each of the learning object. The system also includes an exercise module of the content module to create an assessment format with each of user with each of the assessment format enabling an assessment of each of the user. The system also includes an import module of the content module to enable import of an audio and/or a video file of the learning object to be included with the authoring module. Further, the system includes an evaluation module of the content module to provide a feedback to an interested party and an user-score to a local authority.

### CLAIMS OF PRIORITY

This application claims the benefit of U.S. Utility Applications: application Ser. No. 11/545,969 filed on Oct. 10, 2006, application Ser. No. 11/702,710 filed on Feb. 5, 2007, and application Ser. No. 11/702,836 filed on Feb. 5, 2007.

### FIELD OF TECHNOLOGY

This disclosure relates generally to a field of software technology and associated hardware, and more particularly to an educational content configuration using modular multimedia objects.

### BACKGROUND

Learning material complying with a local authority requirement may be available in limited formats for distribution and use to an individual. An individual may have difficulty in learning the material with a limited format that is provided to them. There may be time constraints for an individual to finish the particular content for learning in a given time. The individual may also have learning disability to learn the learning material in a conventional manner.

The learning material may be authored by the authority in a specific manner. The authority may want to use various means of media and methods to communicate to individuals and may be restrained from portability of data. The learning material may be delivered in a stationary manner, thus preventing the user from accessing the learning material when the user is on a move. The learning material may be delivered as an e-learning material. Furthermore, the e-learning course published on a particular system and may not be easily adaptable for a different media type because learning objects that make up the e-learning course may not be conditioned to execute in the particular media type.

The individual may be home bound for example due to inclement weather or lack of transportation and still want to pursue his learning without disruption.

### SUMMARY

Several methods and a system for educational content configuration using modular multimedia objects are disclosed.

In one embodiment a system includes an authoring module of a content module to create a first meta-data associated with each of a learning object with the first meta-data describing a context of each of the learning object. The system also includes an exercise module of the content module to create an assessment format with each the user with each of the assessment format enabling an assessment of each of the user. The system also includes an import module of the content module to enable import of an audio and/or a video file of the learning object to be included with the authoring module. Further, the system includes an evaluation module of the content module to provide a feedback to an interested party and user-score to a local authority. The system also includes a tagging module of the authoring module to assign a second meta-data to each of the learning objects with the second meta-data describing a context of the each of the learning objects. In addition, the system includes an executable module of the authoring module to generate a set of executable files associated with an electronic device having two or more of the learning objects. Further, the system also includes a course creation module of the authoring module to generate an e-learning course according to a media type of an electronic device based on a set of executable files and other types of files.

The system may include a learning module of a context module to create a set of an interactive content based on a requirement of a user, and a reiteration module of the context module to create a set of learning modules to revise a learning module based on a request by the user. The system may also include a self-evaluation module of the context module to create a self assessment exercise that may enable the user to self evaluate and an update module of the context module to summarize the content of the learning module. Further, the system may include a revision module of the context module to enable the user to write a summary of the interactive content with the learning module, and a reporting module of the context module to provide a feedback to an interested party and a user score to a local authority.

In addition, the system includes a course creation module of the authoring module to create a number of auxiliary files associated with a set of executable files to support the executable files based on the learning objects with an animation, an image, and other media type. The number of auxiliary files may include one or more of a flash file, an image file, a portable document format (pdf) and/or a media file.

The revision module of the context module may enable the user to custom chain the learning objects in an interactive interface. The system may also include a translation module for converting the learning objects from one language to another language as specified by the user. The content module and the context module may be compatible with a multimedia device and/or an electronic device. The system may include an animation module to enable the user to electronically draw a sketch, a cartoon, a flow chart and/or a note. The system may also include a distance learning module to provide the user with real time access to the content module and the context module.

In another embodiment, a method includes creating a content to comply with a local authority rule, embedding the content to a user profile, a user preferred media and/or a user preferred time, and automatically updating the content on a periodic basis based on a local authority rule change, a change in user profile and/or a media change. The method also includes presenting a solution to a user generated query by an author, analyzing an evaluation form submitted by the user in compliance with a local authority rule using a processor and processing the evaluation form for a specific task in response to the local authority rule. In addition, the method also includes recording the evaluation form to perform retrieval, an archival and a reporting, and updating the evaluation form as a record for one or more of the retrieval, the archival and/or the reporting.

The method may include communicating an e-learning course to a context management module which interfaces with a device of a user choice. The method may also include searching for a learning object in a repository based on a context query data using a processor, and encrypting a learning object of the context module and content module to prevent an unauthorized user from accessing the learning object. Further, the method may also include supporting a media device, a mobile device, a computer and/or a communication device, and enabling a local authority to access the record of a user of choice.

The method may include collecting the learning object to one or more of a reading activity, a reviewing activity, a revising activity and/or an evaluating activity, and writing a summary after the reading activity, the reviewing activity, the revising activity and/or the evaluating activity. The summary may be a game, a comic, a movie, a flash card, a quiz, a text, an audio recording and/or a video recording. The method may include recording a set of finished learning objects to comply with a local authority requirement, and sharing with a peer one or more of the game, the comic, the movie, the flash card, the quiz, the audio recording, and/or the video recording.

Sharing with the peer may require a special permission and/or a group password protection. Further, the method may include accessing the learning object from a remote location, combining the learning object to form a theme, making a game of the learning object for one or more of a single user and a multiple user, and enabling the user to obtain credit to comply with the local authority rule. The learning object may be condensed to deliver on a mobile device in a modular form. The method may also include enabling the user to access a condensed learning object on the mobile device. In addition, the method may include creating a revision card for a specific topic of the learning object, and accessing the revision card in an electronic device, a network application and a print media.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a systematic view illustrating communication between a content module and a context module through a network, according to one embodiment.

FIG. 2 illustrates an exploded view of the content module illustrated in FIG. 1, according to one embodiment.

FIG. 3 illustrates an exploded view of an authoring module illustrated in FIG. 2, according to one embodiment.

FIG. 4 is an exploded view of the context module illustrated in FIG. 1, according to one embodiment.

FIG. 5 is an exploded view of a learning module illustrated in FIG. 4, according to one embodiment.

FIG. 6 is a system view illustrating a communication between a learning portal, learning platform, and an authoring station, according to one embodiment.

FIG. 7 is a systematic view illustrating various layers of a learning system, according to one embodiment.

FIG. 8 is a system view illustrating accessing of an object tool by an administrator as a user, according to one embodiment.

FIG. 9 is a systematic view illustrating an author, a teacher, and a reviewer accessing an object tool for creation of a learning object, according to one embodiment.

FIG. 10 is a system view illustrating content creation through an object creator, according to one embodiment.

FIG. 11 is a system view illustrating creation of a course using an object integrator, according to one embodiment.

FIG. 12 is a system view illustrating accessing of an object tool by a teacher, according to one embodiment.

FIG. 13 is a system view illustrating accessing of an object tool by a parent as a user, according to one embodiment.

FIG. 14 is a system view illustrating a student accessing a learning system through a learning portal, according to one embodiment.

FIG. 15 is a graphical user interface view, according to one embodiment.

FIG. 16 is a graphical user interface view illustrating a group, according to one embodiment.

FIG. 17 is a graphical user interface illustrating a subject selection view, according to one embodiment.

FIG. 18 is a graphical user interface view illustrating the chapters of the selected subject, according to one embodiment.

FIG. 19 illustrates a user interface view on a mobile phone, according to one embodiment.

FIG. 20A is a process flow that illustrates multimedia modeling of an educational requirement based on an institutional standard, according to one embodiment.

FIG. 20B is a continuation of the process flow illustrated in FIG. 12A illustrating additional operations, according to one embodiment.

FIG. 20C is a continuation of the process flow illustrated in FIG. 12B illustrating additional operations, according to one embodiment.

Other features of the present embodiments will be apparent from the accompanying drawings and from the detailed description that follows.

### DETAILED DESCRIPTION

Several methods and a system for educational content configuration using modular multimedia objects are disclosed. Although the present embodiments have been described with reference to specific example embodiments, it will be evident that various modifications and changes may be made to these embodiments without departing from the broader spirit and scope of the various embodiments.

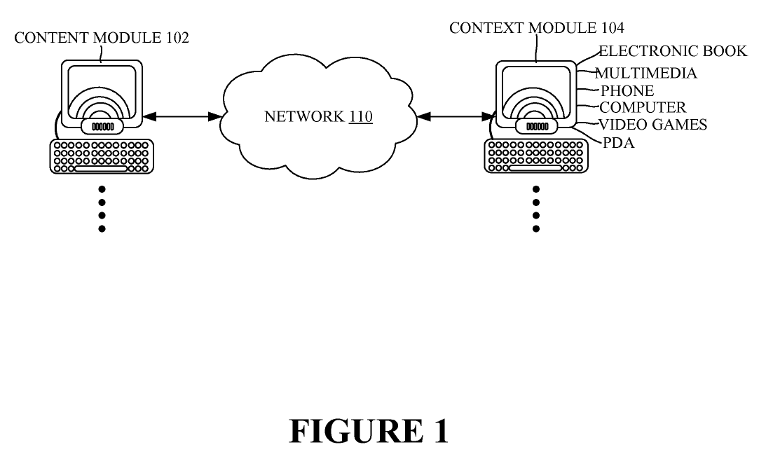

FIG. 1 is a systematic view illustrating communication between a content module and a context module through a network, according to one embodiment.

In one embodiment, a content module 102 may communicate to a context module 104 through a network 110. The context module 104 may include an electronic book, multimedia, a phone, a computer, a video game, a PDA (Portable Digital Assistant), etc. The network 110 may be a LAN, WAN, mobile, telecommunications, internet, intranet, WiFi and/or ZigBee network, etc. The content module 102 may include the multimedia objects related to a course. The multimedia objects may be the learning objects that may include the contents of the course. Furthermore, the learning objects may be modularized based on an educational requirement and institutional standards. The contents of the content module 102 may be provided to a context of the user's choice. A user (e.g., a school, an institution, and/or a person who may opt for a course) may select different contexts based on the required objects and then select a context for the course.

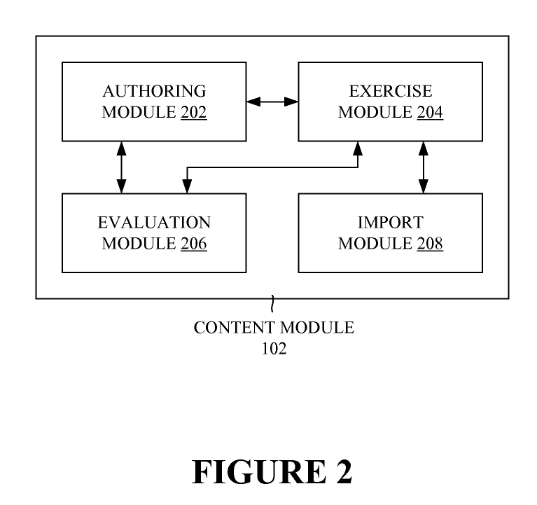

FIG. 2 illustrates an exploded view of the content module illustrated in FIG. 1, according to one embodiment.

In one embodiment, the content module 102 may include an authoring module 202, an exercise module 204, an evaluation module 206, and an import module 208. The authoring module 202 may create a first meta-data associated with each learning object. The learning object may be a course associated with the curriculum of a school and/or an educational institution. In one or more embodiments, the learning object may be an information object, an interactive object, a test object, etc. that may include executable files. The exercise module 204 may create an assessment format (e.g., prototype) for each of the users. The evaluation module may provide an evaluation form to the user. The user may be provided a feedback and/or a score for the assessment through the evaluation module 206. The import module 208 may enable to import an audio/video file of the learning object pertaining to a user.

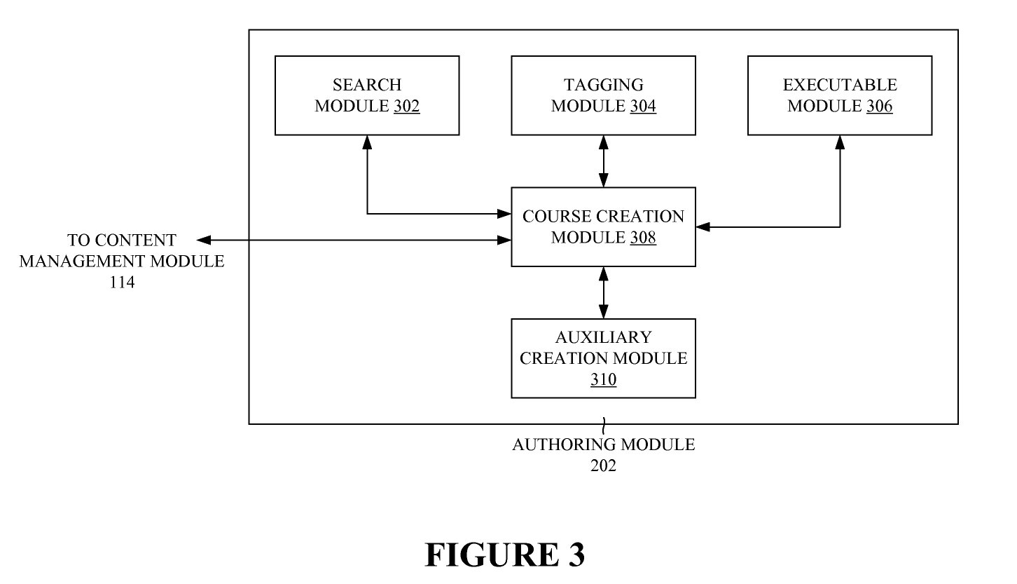

FIG. 3 illustrates an exploded view of an authoring module illustrated in FIG. 2, according to one embodiment.

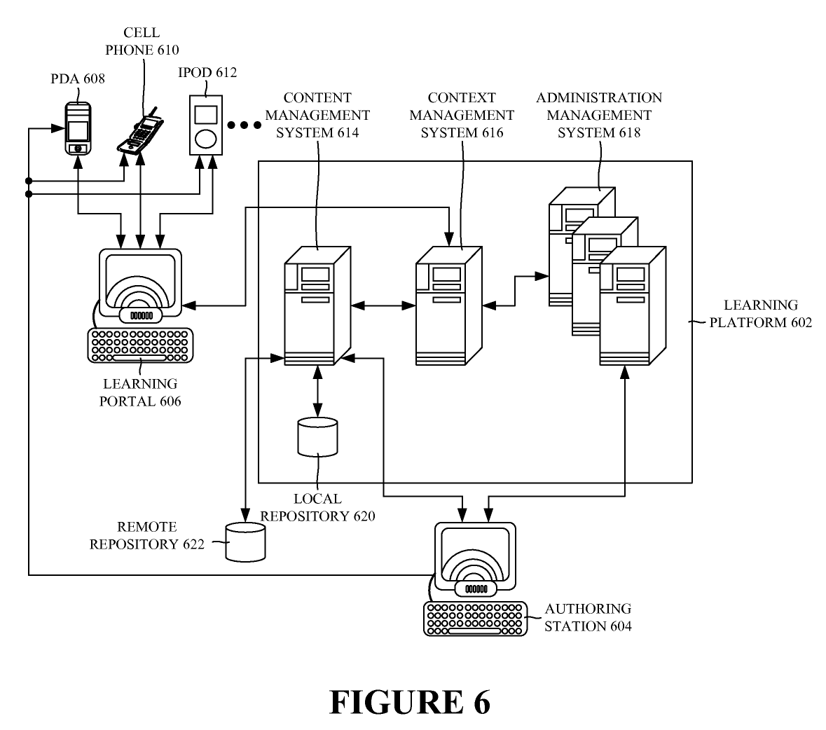

In an embodiment, the authoring module 202 may include a search module 302, a tagging module 304, an executable module 306, a course creation module 308, and an auxiliary creation module 310. The search module 302 may be a search engine that may enable a user to search for a learning object in a repository (e.g., a remote repository 622 and/or a local repository 620 as illustrated in FIG. 6). The learning object may be searched based on a query data using a processor.

The tagging module 304 may assign a second metadata to each of the learning objects. The meta-data may describe a context of the learning objects. The executable module 306 may generate a set of executable files associated with an electronic device and the executable files may be related to the learning objects. The course creation module 308 may generate a course according to a media type of an electronic device based on a set of executable files and other types of files. Furthermore, the course creation module 308 may create auxiliary files associated with a set of executable files of the learning objects. The auxiliary files may include a flash file, an image file, a PDF file, a media file, etc.

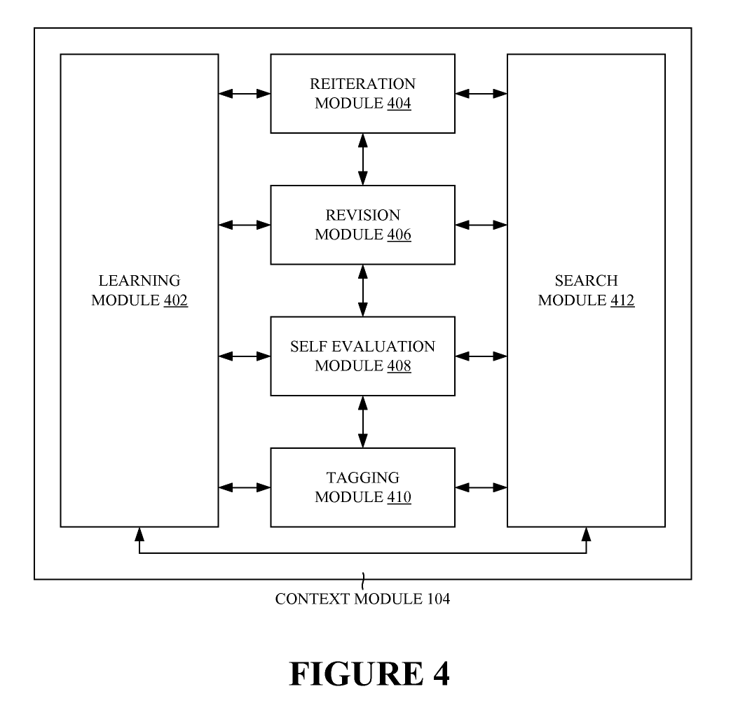

FIG. 4 is an exploded view of the context module illustrated in FIG. 1, according to one embodiment.

In an embodiment, the context module 104 may include a learning module 402, a reiteration module 404, a revision module 406, a self evaluation module 408, a tagging module 410, and a search module 412. In one or more embodiments, the user may select a course to study online or the user may select to study in virtual school. The learning module 402 may create a set of an interactive objects based on a requirement of the user. The user may prefer to revise (e.g., recap) learning object of the course and may request for the learning objects from the reiteration module 404. When the user wishes to perform self assessment, the revision module 406 may provide the user a brief summary of the learning object that may enable the user to recap the studied subject. Further, the revision module 406 may also enable the user to custom chain the learning objects in an interactive interface. The self assessment exercise may be created by the self evaluation module 408. The self assessment exercise created by the self assessment evaluation may 408 may be related to the subject matter of the user's course. The tagging module 410 may provide a meta-data of the learning object that describes the context of the learning object to the learning module 402.

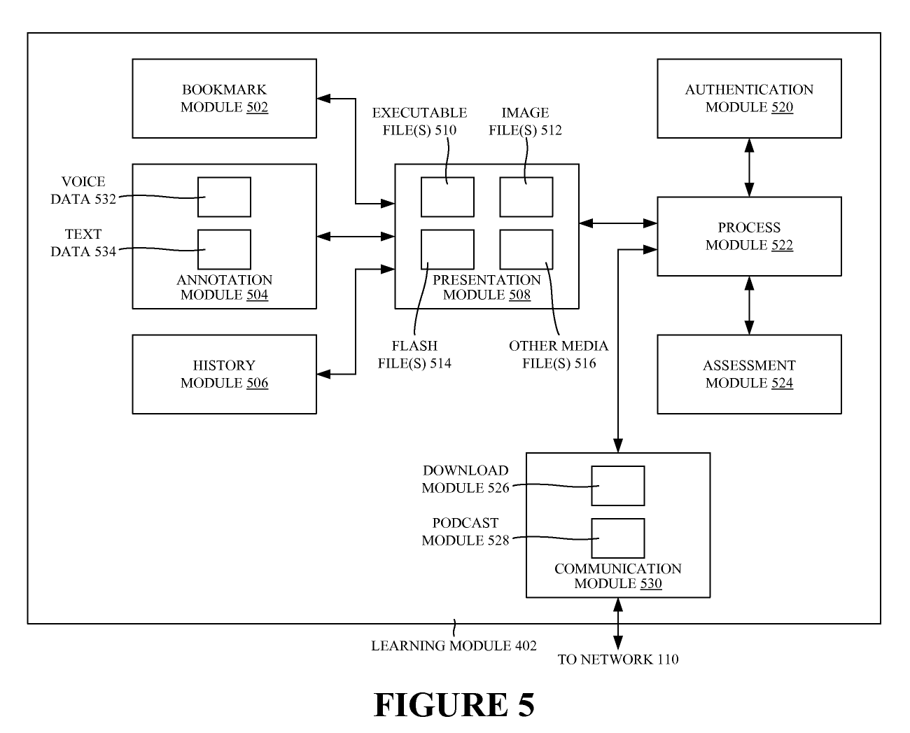

FIG. 5 is an exploded view of a learning module illustrated in FIG. 4, according to one embodiment.

In an embodiment, the learning module may include a bookmark module 502, an annotation module 504, a history module 506, a presentation module 508, an authentication module 520, a process module 522, an assessment module 524, and a communication module 530. The user may have to register with an administration management system 618 (e.g., virtual school system, and/or an institution) to study a course. After registration the user may be provided with a user name and a password to enable the user to access the related learning objects. The authentication module 520 may verify the user name and the password provided by the user. The executable file of the learning object requested by the user may be processed by the process module 522. The processed executable file and/or an auxiliary file may be presented to the user using the presentation module 508.

The presentation module may present an executable file 510, an image file 512, a flash file 514, and/or other media file 516 based on the user's request. The executable file 510 may be related to a learning object of the user's theme. The bookmark module 502 may allow the user to locally store an URL of a favorite page of an online study object (e.g., a learning object). The annotation module 504 may provide an explanation of a particular entity, content, and/or a topic chosen by the user. The explanation provided by the annotation module 504 may include either a text data 534 and/or a voice data 532. The text data 534 and the voice data 532 may include a comment, notes, etc. that may be used to annotate a content/topic of the user's choice illustrated on a particular page.

The history module 506 may generate a list of pages, and/or a list of URLs of the web pages that may be viewed by the user. The assessment module 524 may provide an assessment exercise to the user and provide assessment result to the user. The communication module may enable the user to communicate with a host system to access the related learning objects, and/or assessment exercises of the course. A download module 526 may enable the user to download application programs, executable files, image files, auxiliary files, etc. on the electronic device. A podcast module 528 may allow the user to download a series of media files related to a course at regular intervals through a web consortium.

FIG. 6 is a system view illustrating a communication between a learning portal, learning platform, and an authoring station, according to one embodiment.

In one embodiment, the learning portal may enable the user to access a learning a platform 602, and register to a virtual school, and/or an educational institution that may facilitate online studies. The learning portal may be a desktop computer, a netbook, laptop, etc. The user may also use a Personal Digital Assistance (PDA) 608, a cell phone 610 and/or an ipod® 612 to store and browse a learning object of the course. The PDA 608 may be a handheld mobile phone, a palmtop, etc. that may enable the user to access the digital data related to a course.

In another embodiment, the learning objects may be distributed (e.g., published) to the users by a content management system 614 based on the content query made by the users. A virtual school and/or an online course may be controlled by an administration management system 618. The virtual school and/or an educational institution may be managed based on government framed rules, institutional rules, etc.

In one or more embodiments, the user may be allowed to access the learning objects through a query. The user may be allowed to access the learning objects only after registering for a course through the administration management system 618. The administration management system 618 may provide the user details of the course, credit of the course, etc. The learning objects may be stored in a local repository 620 and/or a remote repository 622 and may be accessed by the registered users through a query. Even the administration module may enable the user to access only the related learning objects. An authorizing station 604 may verify the authenticity of the user and may allow the user to access only the authorized learning objects. A context management system 616 may provide the users a context to display the learning objects based on the type of the course and the objects associated with learning object.

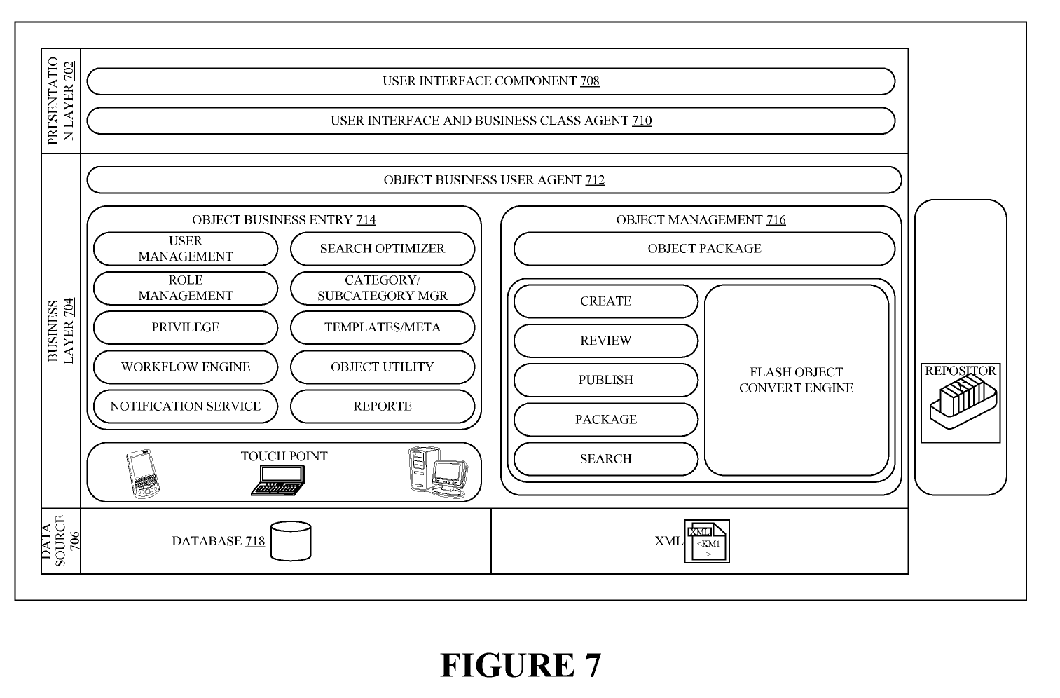

FIG. 7 is a systematic view illustrating various layers of a learning system, according to one embodiment.

In one embodiment, a learning system may include a presentation layer 702, a business layer 704, and a data source 706. The presentation layer 702 may include a user interface component 708 and a user interface and business class agent 710. The user interface component 708 may be a graphical user interface that may allow a user to interact with the learning system for registration, accessing the learning objects, creation of the objects, etc.

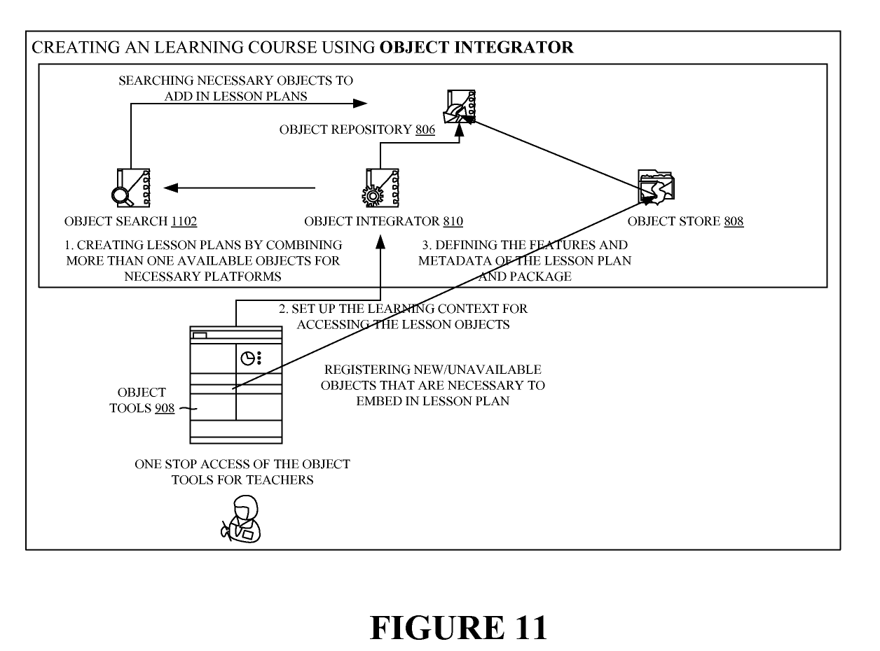

The business layer 704 may include different units to perform and manage trading of objects associated with the learning system. For example, the business layer 704 may include an object business user agent 712, an object business entity 714, and/or an object management 716. The object business entity 714 may perform a user management task to manage the different users registered with the learning system. In addition, the object business entity 714 may perform role management function by allocating roles (e.g., author, object creator, teacher, reviewer, etc.) and associated responsibilities to the individuals associated with the learning system. Furthermore, the object business entity 714 may monitor workflow of the users, provide notification service and a search optimizer (e.g., object search 1102 as illustrated in FIG. 11), and generate reports. In addition to the aforementioned tasks, the object business entity 714 may perform other functions such as setting access privileges to different roles, managing different categories and sub categories of the learning system, etc.

The object management 716 may monitor object creation, content creation, etc. that may be required for a course of the learning system. The object management 716 may also manage reviewing of the created objects, publishing of the created objects, packaging the objects for reuse, searching the objects stored in the repository, etc. The data source 706 may include a database 718 to store the data associated with the users, learning course objects, etc.

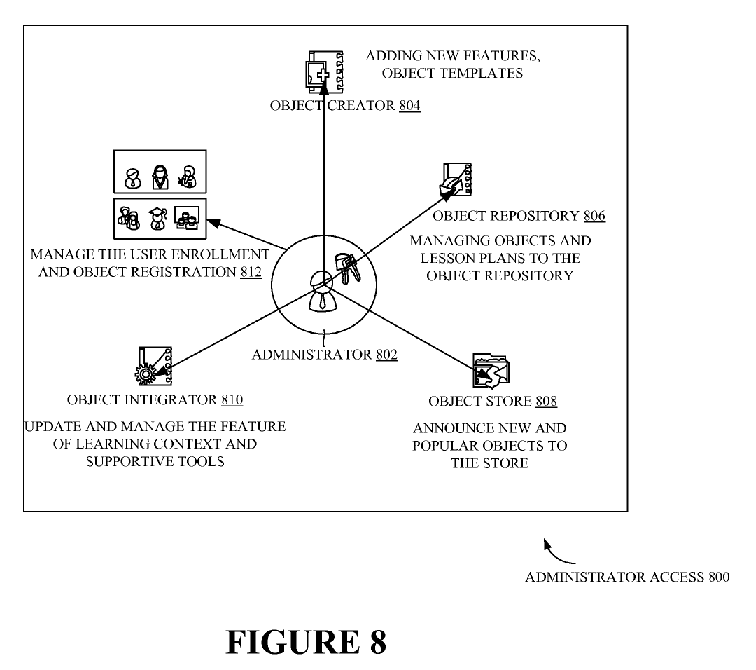

FIG. 8 is a system view illustrating accessing of an object tool by an administrator as a user, according to one embodiment.

In one or more embodiments, an administrator 802 may manage the enrollment of the users to different courses (e.g., manage the user enrollment and object registration 812), set up the course authors, manage objects, etc. The administrator 802 may perform a function of an object creator 804 by creating new objects, and adding new features to the course. The objects (e.g., lesson plans, assessment files, etc.) of the course may be stored in an object repository 806 and the administrator 802 may manage the objects in the object repository 806. The administrator 802 may announce new objects and/or popular objects through an object store 808.

Furthermore, the administrator may perform the tasks of an object integrator 810 by integrating the objects to modulate (e.g., revise) the courses, and updating and/or managing the features of learning context and supportive tools. The object integrator 810 may provide multiple deliveries of objects on one or more digital platforms (e.g., PC, iphone, PDA, mobile phone, gaming console, etc.) In an alternative embodiment, the administrator 802 may update a frequently changed/updated state and national curriculum standard, new themes and learning contexts, etc. Also, the enrollment of users to a course and registration of objects associated with the course may be monitored by the administrator 802.

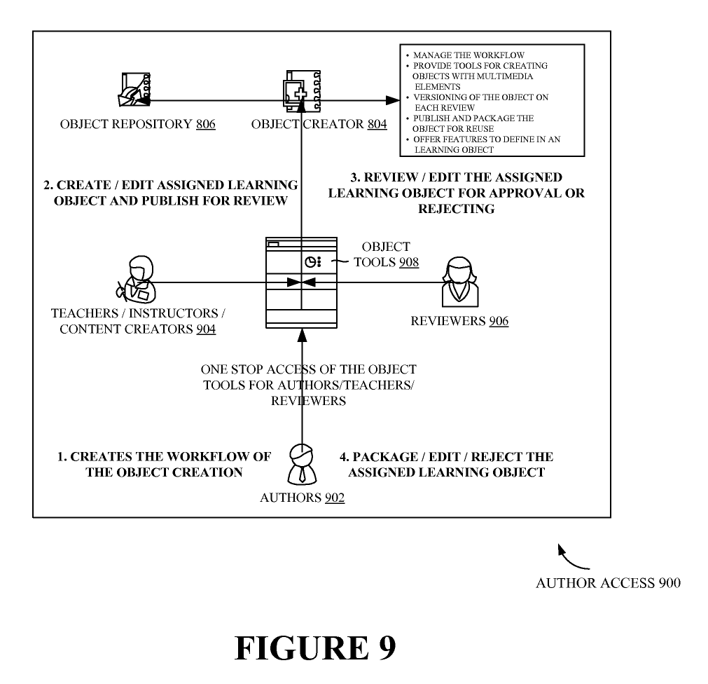

FIG. 9 is a systematic view illustrating an author, a teacher, and a reviewer accessing an object tool for creation of a learning object, according to one embodiment.

In or more embodiments, authors 902 may create work flow of the object creation and manage the work flow by scheduling and tracking the workflow of the content creation of the objects (e.g., learning objects). The contents of the learning objects may be created by teachers/instructors/content creators 904 using the object creator 804 and the created objects may be stored in the object repository 806. The object creator 804 may provide tools for creating objects with multimedia elements. Also, the teachers/instructors/content creators 904 may edit the assigned learning objects and publish for review.

Furthermore, reviewers 906 may review the assigned learning objects and if required edit the learning objects and provide to the authors 902 for approval. The authors 902 may approve and publish the assigned objects, and edit/reject the assigned learning objects. In additions, the authors 902 may perform version control of the learning objects according to the reviews and edits.

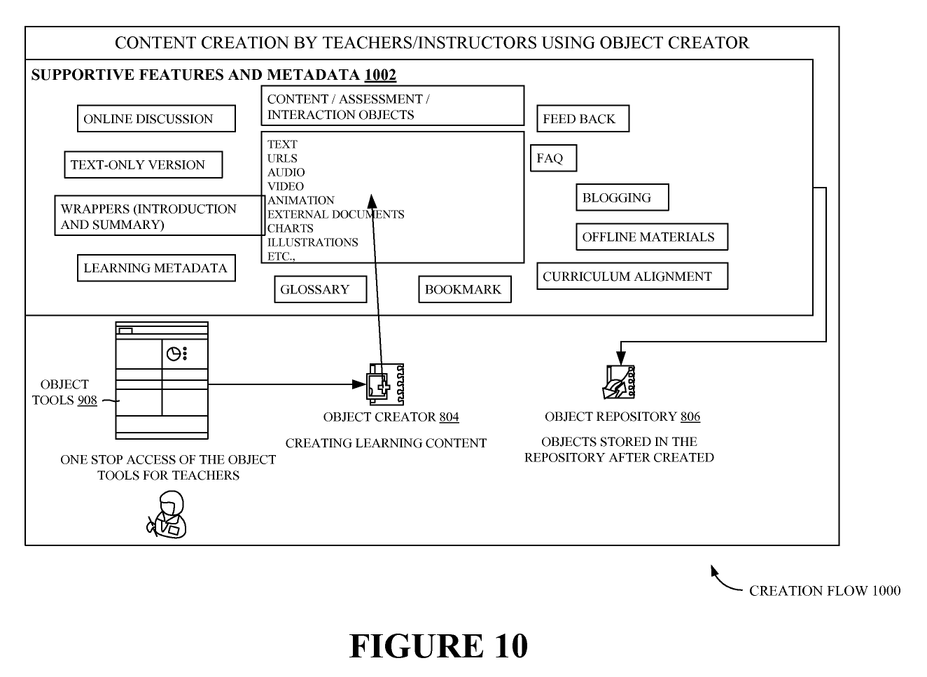

FIG. 10 is a system view illustrating content creation through an object creator, according to one embodiment.

In one or more embodiments, a teacher/instructor may create a content of the learning object using the object creator 804. The content may be created based on lesson planning, and/or curricular standards prescribed by state government and/or national government. The object creator 804 may be accessed by a teacher/instructor through the object tools 908. The contents may be created based on the learning needs and the other features as illustrated in a table supportive features and metadata 1002.

In another embodiment, the supportive features and metadata 1002 may provide online discussion feature which may enable a student to interactively discuss the lessons with the teachers. The content, interaction object, and/or an assessment may be created using graphics, animation, text version, etc. The other features included by supportive features and metadata 1002 may be wrappers (introduction and summary), learning meta-data, feedback, FAQ (Frequently Asked Questions), blogging, offline materials, curriculum alignment, glossary, bookmark, etc.

The feature wrappers (introduction and summary) may provide brief summary of the content (e.g., syllabus, course overview, etc.). The feedback feature may enable the learners to offer feedback and rating on learning experience. Furthermore, the feature curriculum alignment may align the lessons and courses according to state and national standards. In yet another embodiment, after creation the content may be stored in the object repository 806.

In an alternative embodiment, a teacher/instructor may access learning objects residing on multiple learning systems using an object search (e.g., object search 1102 of FIG. 11). In another embodiment, the teacher/instructor may also create learning object through the object creator 804 according to the learning needs, curriculum alignment, lesson planning and/or learning experience.

FIG. 11 is a system view illustrating creation of a course using an object integrator, according to one embodiment.

In one or more embodiments, a teacher may register new/unavailable objects that are necessary to be embedded in a lesson plan. The lesson plans of a learning course may be created by combining the learning objects available in the object repository 806. The necessary learning objects stored in the object repository 806 may be searched using an object search 1102. Next, various contexts of learning environment may be set up to access the learning objects according to a requirement of an individual and/or a specific learning group. For example, the learning environment may be web 2.0 portal, scenario based learning, story based learning, etc.

In another embodiment, the object search 1102 may include the supportive tools to access the learning objects from the object repository 806. For example, the learning objects may be searched based on curriculum concept, topic, keyword, etc. In yet another embodiment, after creation of the lessons associated with a course, the course may be published in the object store 808. The interactive exercise objects may be included in the course for self evaluation of the students.

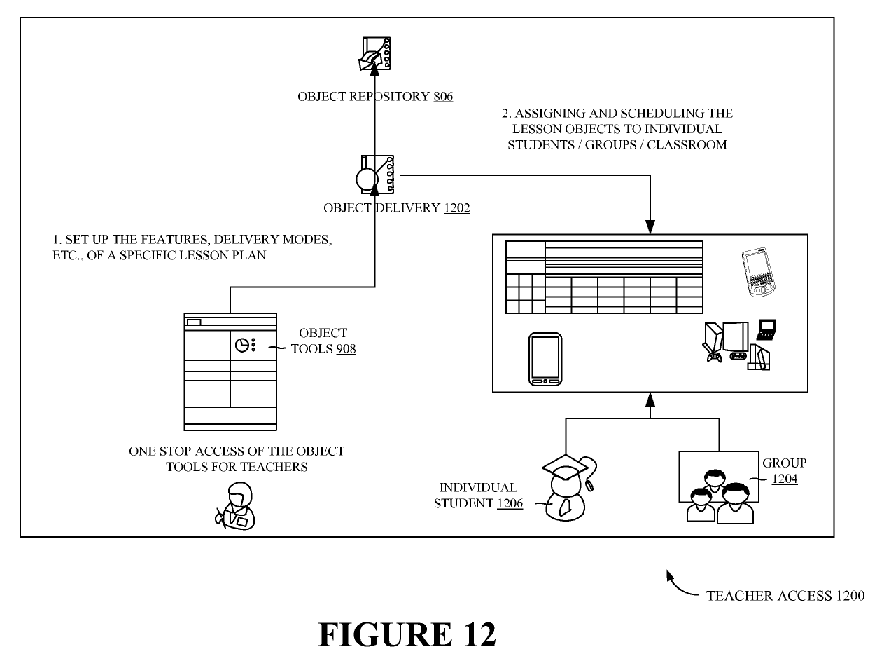

FIG. 12 is a system view illustrating accessing of an object tool by a teacher, according to one embodiment.

According to one embodiment, a teacher/instructor may create a course content in multiple languages to reach more learners. A lesson object associated with an individual student, group/classroom may be assigned and scheduled to deliver. The delivery modes of specific lesson plans may be set up by the teacher. Before delivering to the learning portals (e.g., iphone, desktop PC, mobile phone, PDA, etc.) of the users (e.g., individual student 1206, a group 1204) the learning object may be encrypted to prevent unauthorized access. The learning objects may be enabled with features such as wrappers (introduction and summary), glossary, related objects, online discussions, blogging, forums, etc.

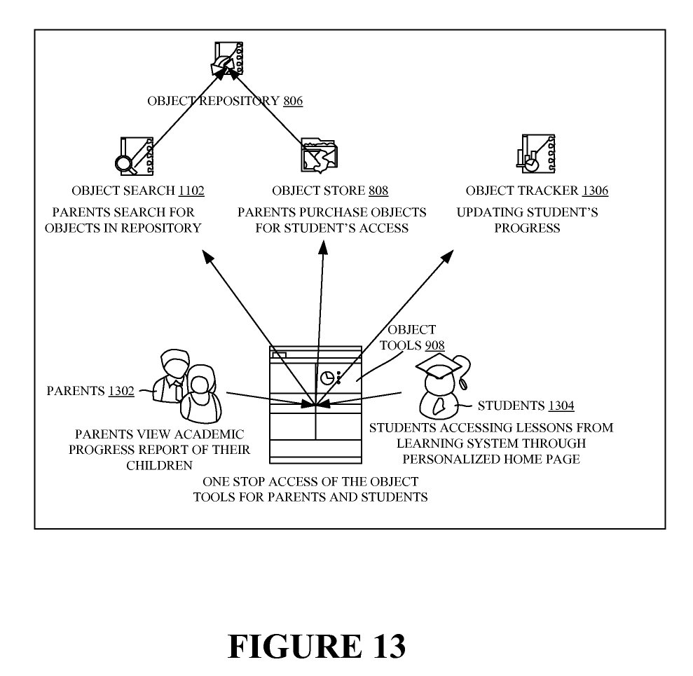

FIG. 13 is a system view illustrating accessing of an object tool by a parent as a user, according to one embodiment.

According to one embodiment, parents 1302 may monitor academic progress of their children (e.g., students 1304) through an object tracker 1306. The object tools 908 may provide access to the object tracker 1306, the object store 808, an object search 1102, and the object repository 806. The parents 1302 may register and purchase learning objects available in the object store 808 for student's access. Further, the parents 1302 and the students 1304 may search for a specific learning objects and/or lesson plans through the object search 1102 engine. The students 1304 may access lessons (e.g., associated with the learning objects) through the learning portal 606 (e.g., cell phone, ipod®, PDA, etc.). In an alternative embodiment, the parents 1302 may communicate to teachers and parent's community through forums and blogs.

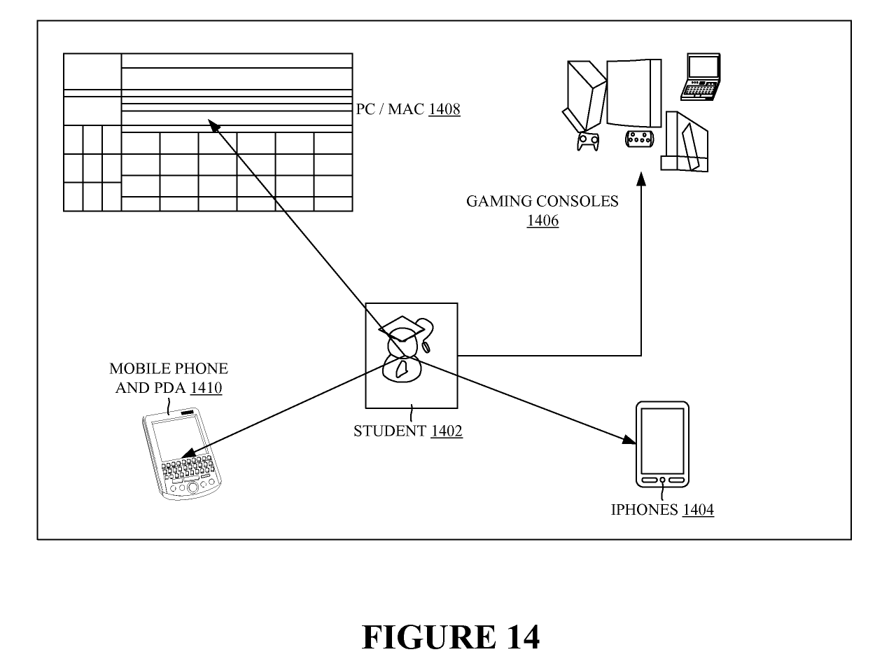

FIG. 14 is a system view illustrating a student accessing a learning system through a learning portal, according to one embodiment.

In one or more embodiments, a student 1402 may obtain a personalized learning environment on a learning portal by registering with the learning system. The learning portal may be an iphone 1404, a gaming console 1406, a PC/MAC 1408, a mobile phone and/or PDA 1410, etc. The student 1402 may access learning content from multiple learning systems, download offline activities from the learning system, submit the assignments, and/or view academic progress through a home page on the learning portal. Furthermore, the student 1402 may view daily/monthly schedule of their lessons/courses, and provide feedback and rating based on the learning experience. The student 1402 may communicate with teachers through interactive discussion sessions, and further the student 1402 may also communicate with teachers and other students through blogging, and/or forums.

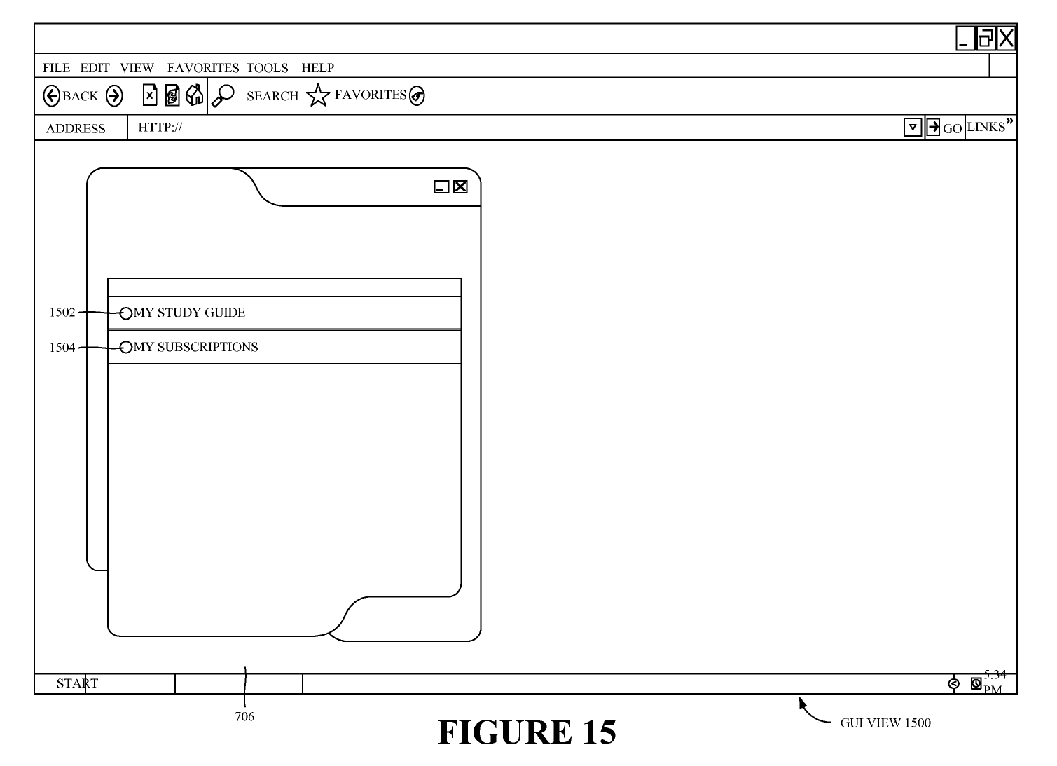

FIG. 15 is a graphical user interface view, according to one embodiment.

According to one embodiment, a graphical user interface view 1500 illustrates an option my study guide 1502 and an option my subscription 1504. In one or more embodiments, the option my study guide 1502 may provide the details of a virtual school, and/or a course offered by an educational institution. The details may include the description of the course, the subjects of the course, credits of the course, mode of paying the fees, etc. Furthermore, the option my subscription 1504 may enable the user to subscribe for a course.

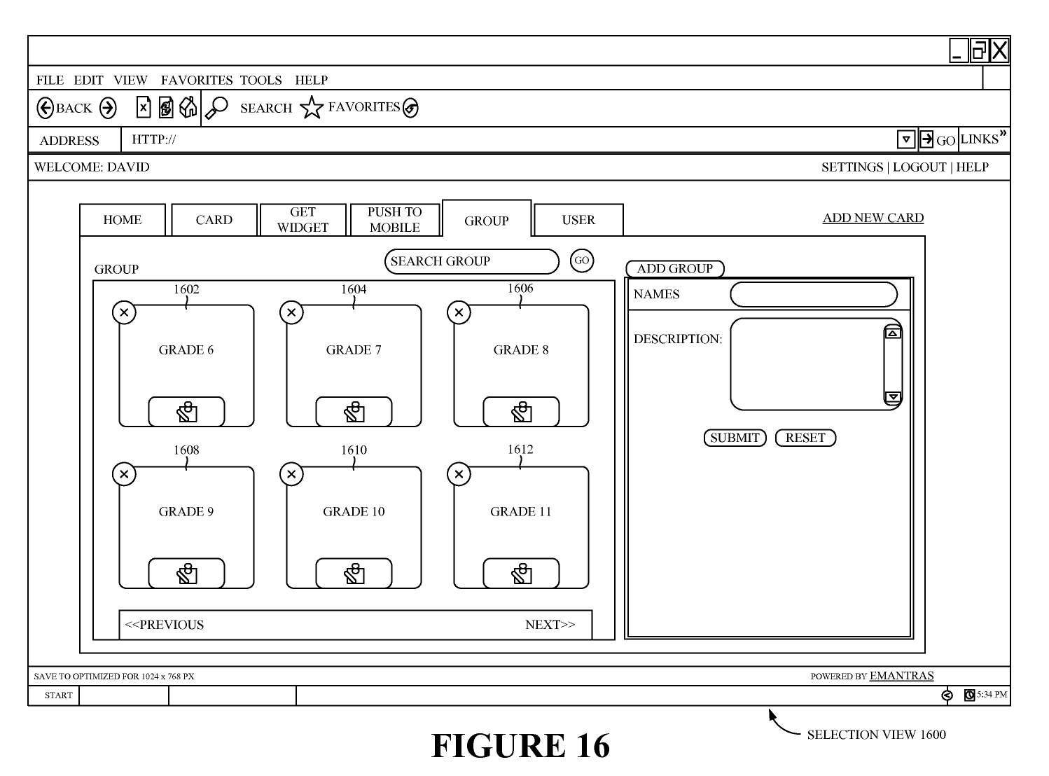

FIG. 16 is a graphical user interface view illustrating a group, according to one embodiment.

According to one embodiment, the graphical user interface of FIG. 16 illustrates a group that may include grades. The different grades (e.g., grade 1602-1612) displayed in the group may indicate the scores of the users.

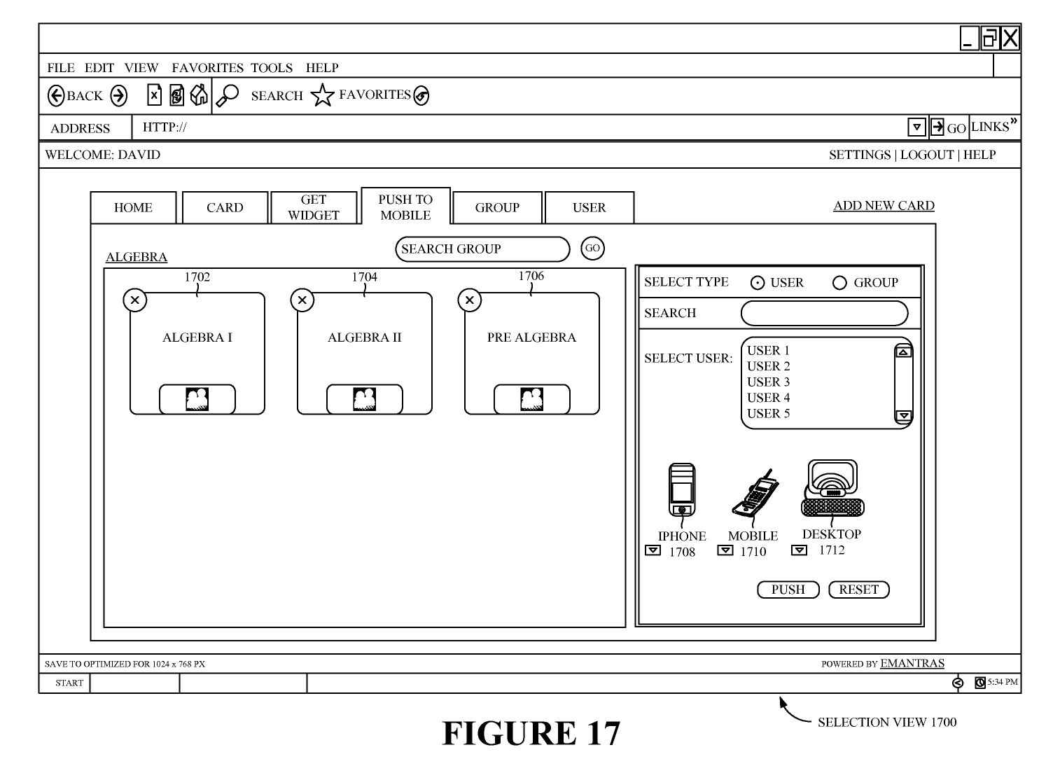

FIG. 17 is a graphical user interface illustrating a subject selection view, according to one embodiment.

The user may select a subject (e.g., algebra I 1702, algebra II 1704, pre algebra 1706) to study and push the contents of the subject on a phone 1708, a mobile 1710, and/or a desktop 1712 so that the learning objects may be available to the user even in an offline state.

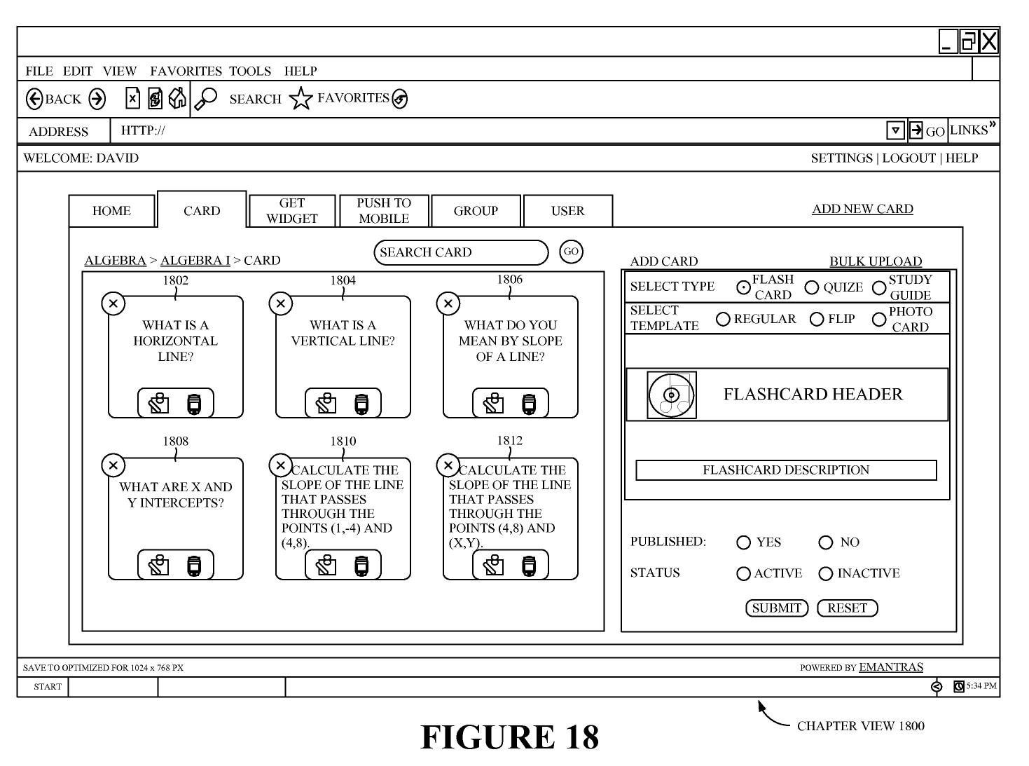

FIG. 18 is a graphical user interface view illustrating the chapters of the selected subject, according to one embodiment.

In one embodiment, the chapters associated with the selected subjects and the associated cards (e.g., 1802-1812 as illustrated in FIG. 18) may be displayed on a graphical user interface (e.g., chapter view 1800). The user may select a chapter for studying and the contents associated with the chapter may be provided to the user based on the user's preferred context.

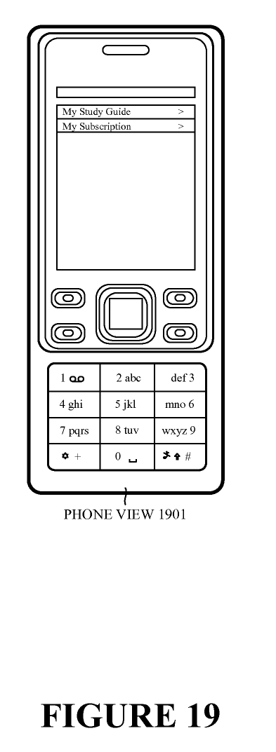

FIG. 19 illustrates a user interface view on a mobile phone, according to one embodiment.

A user interface illustrated on a phone view 1901 may display the options my study guide and my subscription option to the user. The user may obtain the details of the course by selecting the option my study guide and also the user can subscribe to a course by selection the option my subscription.

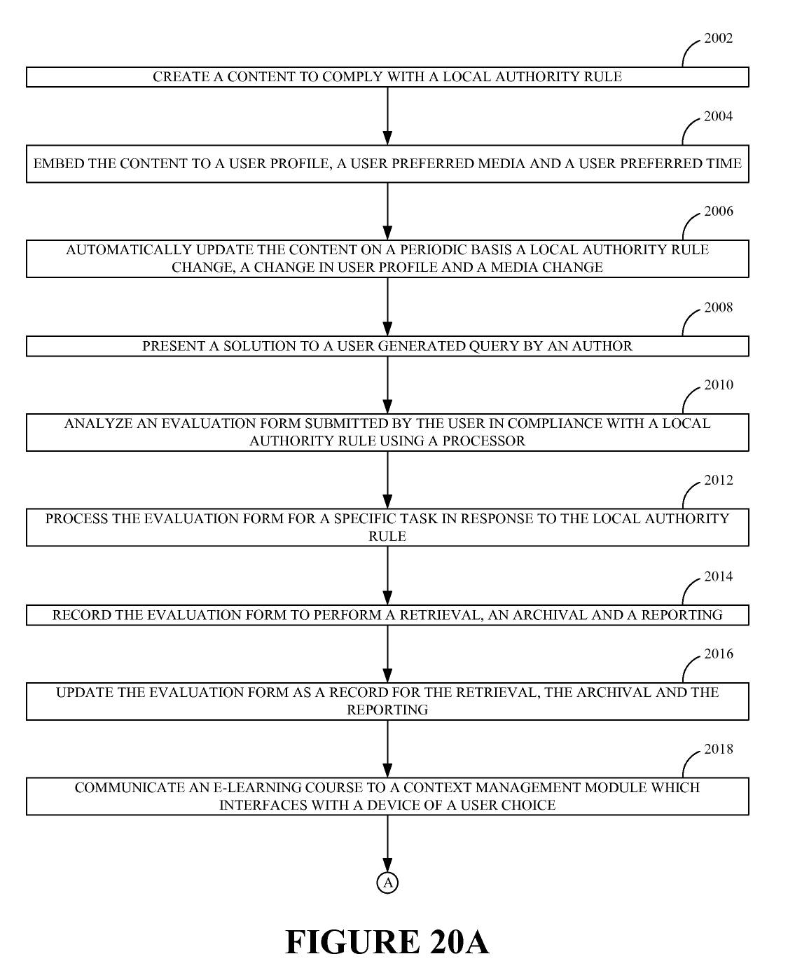

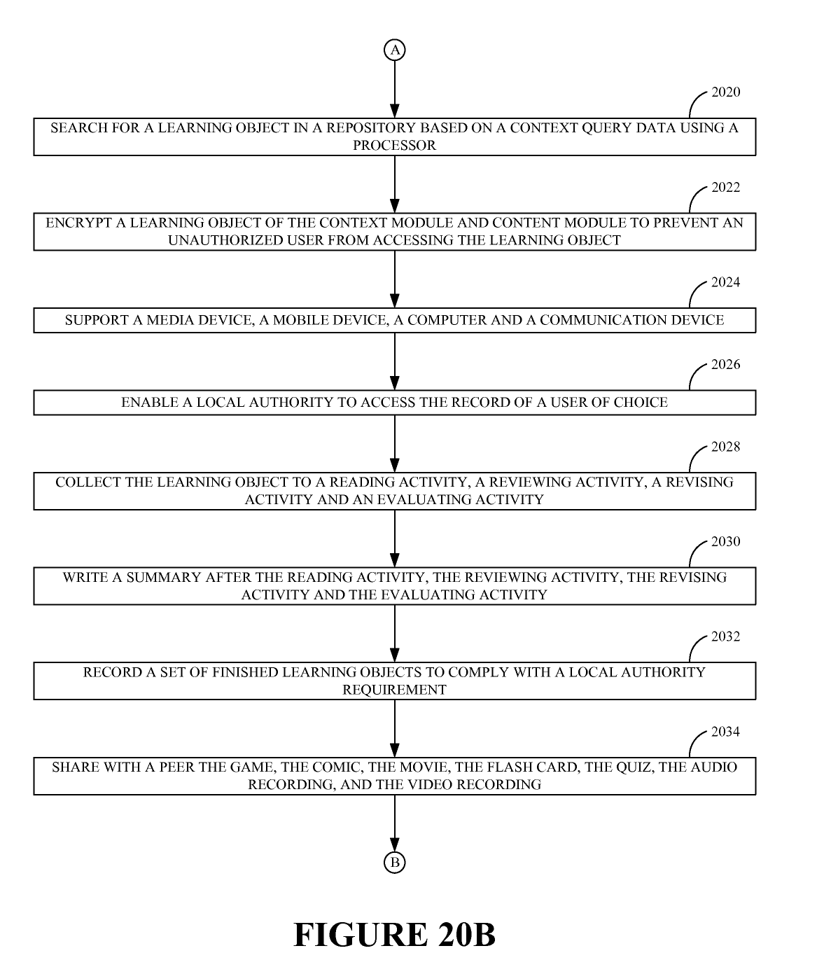

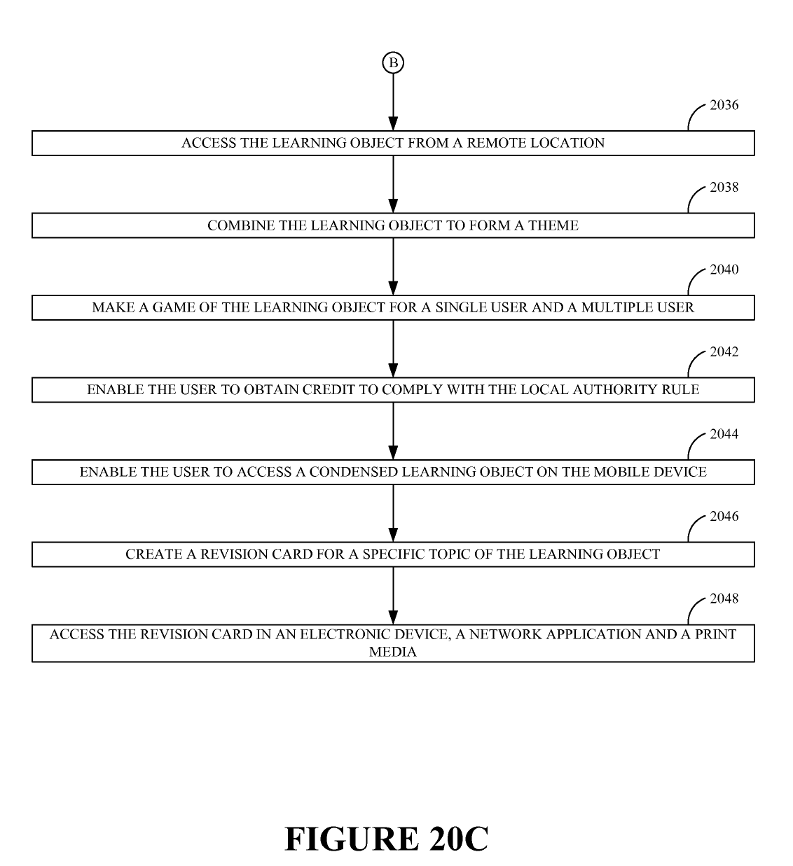

FIG. 20A is a process flow that illustrates multimedia modeling of an educational requirement based on an institutional standard, according to one embodiment.

In operation 2002, a content may be created to comply with a local authority rule. In operation 2004, the content may be embedded to a user profile, a user preferred media and/or a user preferred time. In operation 2006, the content may be automatically updated on a periodic basis based on a local authority rule change, a change in user profile and a media change. In operation 2008, a solution may be presented to a user generated query by an author.

In operation 2010, an evaluation form submitted by the user may be analyzed in compliance with a local authority rule using a processor. For example, the evaluation may be performed by the evaluation module 206 of FIG. 2. In operation 2012, the evaluation form may be processed for a specific task in response to the local authority rule. In operation 2014, the evaluation form may be recorded to perform retrieval, archival and reporting purposes. In operation 2016, the evaluation form may be updated as a record for the retrieval, the archival and the reporting. In operation 2018, an e-learning course may be communicated to the context module 104 which interfaces with a device of a user choice.

FIG. 20B is a continuation of the process flow illustrated in FIG. 20A illustrating additional operations, according to one embodiment.

In operation 2020, a learning object may be searched in a repository (e.g., a local repository 620 and/or a remote repository 622) based on a context query data using a processor. In operation 2022, a learning object of the context module 104 and content module 102 may be encrypted to prevent an unauthorized user from accessing the learning object. In operation 2024, a media device, a mobile device, a computer and/or a communication device may be supported by the context module 104.

In operation 2026, a local authority may be enabled to access the record of a user of choice. In operation 2028, the learning object may be collected to a reading activity, a reviewing activity, a revising activity and/or an evaluating activity. In operation 2030, a summary may be written after the reading activity, the reviewing activity, the revising activity and/or the evaluating activity. In operation 2032, a set of finished learning objects may be recorded to comply with a local authority requirement. In operation 2034, the game, the comic, the movie, the flash card, the quiz, the audio recording, and the video recording may be shared with a peer.

FIG. 20C is a continuation of the process flow illustrated in FIG. 20B illustrating additional operations, according to one embodiment.

In operation 2036, the learning object may be accessed from a remote location. In operation 2038, the learning object may be combined to form a theme. In operation 2040, a game of the learning object may be made for a single user and/or a multiple user.

In operation 2042, the user may be enabled to obtain credit to comply with the local authority rule. In operation 2044, the user may be enabled to access a condensed learning object on the mobile device. In operation 2046, a revision card may be created for a specific topic of the learning object. In operation 2048, the revision card may be accessed in an electronic device, a network application and a print media.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A system, comprising:
an authoring module of a content module to create a first meta-data associated with each of a learning object with the first meta-data describing a context of each of the learning object;
an exercise module of the content module to create an assessment format with each of a plurality of users with each of the assessment format enabling an assessment of each of the plurality of users;
an import module of the content module to enable import of at least one of an audio and a video file of the learning object to be included with the authoring module;
an evaluation module of the content module to provide at least one of a feedback to an interested party and an user-score to a local authority;
a tagging module of the authoring module to assign a second meta-data to each of the learning objects with the second meta-data describing a context of the each of the learning objects;
an executable module of the authoring module to generate a set of executable files associated with an electronic device having the plurality of the learning objects; and
a course creation module of the authoring module to generate an e-learning course according to a media type of an electronic device based on a set of executable files and other types of files.

2. A system of claim 1, further comprising;
a learning module of a context module to create a set of an interactive content based on a requirement of an user;
a reiteration module of the context module to create a set of learning modules to revise a learning module based on a request by the user;
a self-evaluation module of the context module to create a self assessment exercise that enable the user to self evaluate;
an update module of the context module to summarize the content of the learning module;
a revision module of the context module to enable the user to write a summary of the interactive content with the learning module; and
a reporting module of the context module to provide at least one of a feedback to a interested party and an user score to a local authority.

3. The system of claim 2 further comprising a course creation module of the authoring module to create a number of auxiliary files associated with a set of executable files to support the executable files based on the learning objects with an animation, an image, and other media type, wherein the number of auxiliary files to include at least one of a flash file, an image file, a portable document format (pdf) and a media file.

4. The system of claim 2, wherein the revision module of the context module enables the user to custom chain the learning objects in an interactive interface.

5. The system of claim 2 further comprising a translation module for converting the learning objects from one language to another language as specified by the user.

6. The system of claim 2, wherein the content module and the context module are compatible with at least one of a multimedia device and an electronic device.

7. The system of claim 2 further comprising an animation module to enable the user to electronically draw at least one of a sketch, a cartoon, a flow chart and a note.

8. The system of claim 7, further comprising a distance learning module to provide the user with real time access to the content module and the context module.

9. A method comprising:
creating a content to comply with a local authority rule;
embedding the content to at least one of a user profile, a user preferred media and a user preferred time;
automatically updating the content on a periodic basis at least one of a local authority rule change, a change in user profile and a media change;
presenting a solution to a user generated query by an author;
analyzing an evaluation form submitted by the user in compliance with a local authority rule using a processor;
processing the evaluation form for a specific task in response to the local authority rule;
recording the evaluation form to perform at least one of a retrieval, an archival and a reporting; and
updating the evaluation form as a record for at least one of the retrieval, the archival and the reporting.

10. A method of claim 9, further comprising communicating an e-learning course to a context management module which interfaces with a device of a user choice.

11. A method of claim 10 further comprising:
searching for a learning object in a repository based on a context query data using a processor;
encrypting a learning object of the context module and content module to prevent an unauthorized user from accessing the learning object;
supporting at least one of a media device, a mobile device, a computer and a communication device; and
enabling a local authority to access the record of a user of choice.

12. A method of claim 11 further comprising:
collecting the learning object to at least one of a reading activity, a reviewing activity, a revising activity and an evaluating activity; and
writing a summary after at least one of the reading activity, the reviewing activity, the revising activity and the evaluating activity;

13. A method of claim 12, wherein the summary is at least one of a game, a comic, a movie, a flash card, a quiz, a text, a audio recording and a video recording.

14. A method of claim 12 further comprising:
recording a set of finished learning objects to comply with a local authority requirement; and
sharing with a peer at least one of the game, the comic, the movie, the flash card, the quiz, the audio recording, and the video recording.

15. A method of claim 14, wherein sharing with the peer requires a special permission and a group password protection.

16. A method of claim 12 further comprising:
accessing the learning object from a remote location;
combining the learning object to form a theme;
making a game of the learning object for at least one of a single user and a multiple user; and
enabling the user to obtain credit to comply with the local authority rule.

17. A method of claim 12, wherein the learning object is condensed to deliver on a mobile device in a modular form.

18. A method of claim 12 further comprising:
enabling the user to access a condensed learning object on the mobile device.

19. A method of claim 12 further comprising:
creating a revision card for a specific topic of the learning object; and
accessing the revision card at least in an electronic device, a network application and a print media.

20. A system of claim 19 further comprising a notification system to update the user for updates.
